(19) United States
(12) Patent Application Publication
(10) Pub. No.: US 2005/0215778 A1
(43) Pub. Date: Sep. 29, 2005

(54) Method for the production of cellulose carbamate by means of reactive extrusion

(76) Inventors: Fritz Loth, Teltow (DE); Hans-Peter Fink, Teltow (DE); Peter Weigel, Kleinmachnow (DE)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/515,754

(22) PCT Filed: May 9, 2003
(86) PCT No.: PCT/EP03/04880

§ 371 Date: May 16, 2005

(30) Foreign Application Priority Data
May 24, 2002 (DE) 10223172.9
May 28, 2002 (EP) 02077098.8

(51) Int. Cl. B29C 47/78; C08B 3/00

(52) U.S. Cl. 536/32; 264/211.24; 536/56

(57) ABSTRACT

The invention relates to a method for the production of cellulose carbamate by reactive extrusion and for the production of moulded articles made of regenerated cellulose. The method for the production of cellulose carbamate is based thereby on the activation of cellulose, subsequent separation of the activation solution and following thereon reactive extrusion of the activated cellulose. Typical examples of moulded articles which can be produced therefrom are fibres, films, beads, sponges or sponge-type cloths.

The invention relates to a method for the production of cellulose carbamate by reactive extrusion and also for the production of moulded articles made of regenerated cellulose.

At present, considerable quantities of products made of regenerated cellulose, such as fibres, films and other moulded articles, are produced world wide predominantly according to the viscose method. Because of the high environmental impact associated with this method and the considerable investment costs, comprehensive efforts have however been made already for several years to supersede the viscose method with alternative methods. Thus, for example the method has been developed of producing cellulose moulded articles by precipitation of a solution of cellulose in a system comprising N-methylmorpholine-N-oxide and water (DE 44 21 482). However, the method has the disadvantage of a relatively low variation width of product properties.

Furthermore, a general interest resides hence in providing further methods for the production of moulded articles made of regenerated cellulose which fulfil the demands with respect to variation width of the product properties, e.g. of fibres for use in the textile field.

A method for producing moulded articles made of regenerated cellulose, which has been known already for a long time, resides in the production of cellulose. carbamate which is soluble in cold diluted sodium hydroxide solution and can be regenerated again to cellulose in heated sodium hydroxide solution.

The formation of cellulose carbamate is effected by conversion of cellulose with urea with thermal splitting of the urea into isocyanic acid and ammonia and reaction of the isocyanic acid with the OH groups of cellulose. For a sufficiently high concentration and uniform distribution of the carbamate groups, the activation of the cellulose is necessary which extends the crystalline structure of the cellulose such that, in the crystalline regions, just as in the amorphous regions, a sufficiently high urea concentration is present and the reactivity of the hydroxyl groups in the crystalline and the amorphous regions is approximately equal.

A method is described in EP-A 57 105, in which the impregnation is effected with urea and the activation by liquid ammonia. After evaporation of the ammonia, the conversion of the cellulose into cellulose carbamate is effected in a drying cabinet at temperatures above the melting point of the urea. A disadvantage of the method is the high costs due to use of the liquid ammonia at low temperatures. However, an even more substantial disadvantage is that, because of the poor heat conductivity of the cellulose, a uniform temperature distribution in the reaction mixture is not ensured, which leads to inhomogeneity of the substituent distribution of the carbamate groups and hence to a non-uniform product which is difficult to use on an industrial scale.

In the method described in EP-A 178 292, the cellulose is saturated with sodium hydroxide solution and this is subsequently washed out with urea-containing water which incorporates the urea into the cellulose at the same time. After drying, the conversion is effected again at temperatures above the melting point of the urea. However, the above-mentioned problems exist here too with respect to non-uniform substituent distribution.

It is furthermore disadvantageous that, in the described methods at reaction temperatures of 130 to 150 degrees Celsius, reaction times of approximately 2 hours are necessary. Hence, a continuous operation, which is desired for an industrial scale production process, is difficult to achieve.

It is therefore the object of the present invention to provide a method for the production of cellulose carbamate which ensures a continuous production process and delivers good homogeneity of the substituent distribution and hence good product properties. A further method-related object of the invention resides in the fact that the method to be proposed fulfils the demands with respect to low investment and production costs and low environmental impact.

This object is achieved by the method having the features of claim 1 and the cellulose carbamate produced thereby according to claim 11. The further dependent claims reveal advantageous developments. The use of the method is described in claims 13 to 15.

According to the invention, a method for the production of cellulose carbamate is provided which is based on the following method steps:
a) The cellulose is treated with an activation solution of urea in alkali lye.
b) The activation solution is separated from the now activated cellulose.
c) Next, a reactive extrusion of the activated cellulose is effected at temperatures between 180 and 280 degrees Celsius. The ammonia gas released during this reaction is withdrawn simultaneously from the equilibrium.

It was able to be shown surprisingly that, at the mentioned temperatures of the reactive extrusion, a very low reaction time suffices to achieve a substitution degree of approximately 20%. Substitution degrees of this type thereby ensure good solubility of the cellulose carbamate in diluted sodium hydroxide solution. As a result of the short reaction time, the method has the substantial advantage that no thermal damage to the cellulose can occur. The short reaction time thereby allows also problem-free continuous process management in an extruder.

The activation solution has preferably between 5 and 25, preferably between 10 and 20% by weight of sodium hydroxide solution. The weight ratio between sodium hydroxide solution to urea in this solution thereby lies between 4:1 and 1:1, preferably between 3:1 and 2:1.

In an advantageous development of the method, a softener can be added to the activation solution, glycerine and/or. polyethylene glycol being used preferably for this purpose. The proportion of the softener in the activation solution is thereby between 5 and 20% by weight, particularly preferred between 10 and 15% by weight.

After the activation, the separation of the activation solution is achieved preferably by pressing out the cellulose. This pressing is implemented thereby preferably until a mass ratio between cellulose and activation solution of 1:1 to 1:2 has been set.

The reactive extrusion is implemented preferably between 200 and 260 degrees Celsius. The reaction time is thereby preferably between 1 and 10 minutes and particularly preferred between 2 and 5 minutes.

In an advantageous development, the cellulose carbamate is washed out following the reactive extrusion, i.e. the excess urea, the sodium hydroxide solution and further reaction products are separated. The thus obtained cellulose carbamate is soluble in cold 8 to 10% by weight sodium hydroxide solution, the cellulose carbamate concentration between 8 and 10% by weight being able to be achieved.

According to the invention, cellulose carbamate is likewise provided which has been produced according to the method-according to the invention. A particular advantage of the thus produced cellulose carbamate is that a substitution; degree >20% can be achieved, by means of which good solubility of the cellulose carbamate in diluted sodium hydroxide solution is made possible.

The method is used for the production of moulded articles made of cellulose carbamate and/or regenerated cellulose. The cellulose carbamate is hereby converted into a spinning solution by means of alkali lye and said spinning solution is introduced subsequently via shaping nozzles into a regenerating bath. Spinning jets which transfer the spinning solution into the regenerating bath, e.g. sulphuric acid, are used preferably thereby as shaping nozzles. In the same manner, it is possible to produce moulded articles made of regenerated cellulose, the mode of operation by dissolving the cellulose in alkali lye, which is known from the state of the art, being used. Typical examples of moulded articles which can be produced in this manner are fibres, films, beads, sponges or sponge-type cloths.

The subject according to the invention is intended to be explained in more detail with reference to the following examples without limiting said object to these embodiments.

### EXAMPLE 1

200 g pine-sulphate pulp with a DP =510 are immersed in 600 g of an aqueous solution containing 180 g urea, 50 g glycerine and 35 g NaOH for 60 min, centrifuged and pressed to a cellulose content of 43%. The mass is homogenised in a laboratory mixer for 20 min. Subsequently, feeding into a twin screw extruder PTW 25 is effected. The maximum temperature in the discharge zone of the extruder is 240 degrees Celsius. The dwell time in the extruder is 4 min. The dry crumbly mass is washed once with acetous water and three times with deionised water and centrifuged. The moist carbamate has a dry content of 50%, a DP =385 and a nitrogen content of 3.25% relative to the cellulose content.

### EXAMPLE 2

200 g pine-sulphate pulp with a DP =510 are immersed in 600 g of an aqueous solution containing 180 g urea, 50 g glycerine an 35 g NaOH for 60 min, centrifuged and pressed to a cellulose content of 43%. The mass is homogenised in a laboratory mixer for 20 min. Subsequently, feeding into a twin screw extruder PTW 25 is effected. The maximum temperature in the discharge zone of the extruder is 260 degrees Celsius. The dwell time in the extruder is 2 min. The dry crumbly mass is washed once with acetous water and three times with deionised water and centrifuged. The moist carbamate has a dry content of 50%, a DP =345 and a nitrogen content of 3.65% relative to the cellulose content.

1. Method for the production of cellulose carbamate, having the following steps:
(a) activation of the cellulose with an activation solution of urea in alkali lye,
(b) separation of the activation solution from the cellulose,
(c) reactive extrusion of the activated cellulose at a temperature between 180° and 280°, the hereby released ammonia gas being withdrawn from the equilibrium.

2 - 14 (canceled).
